(19) United States
(12) Patent Application Publication
(10) Pub. No.: US 2010/0176541 A1
(43) Pub. Date: Jul. 15, 2010

(54) COMPOSITION FOR CERAMICS WITH CARBON LAYER AND MANUFACTURED METHOD OF CERAMICS USING THIS

(76) Inventor: Koo-Han Kim, Gyeonggi-do (KR)

Correspondence Address: Thomas R. Vigil Law Offices, 319 Bluff Court, Lake Barrington, IL, 60010, US

(21) Appl. No.: 12/450,828

(22) PCT Filed: Apr. 13, 2007
(86) PCT No.: PCT/KR2007/001821

§ 371 Date: Oct. 13, 2009

(51) Int. Cl. C04B 33/04; C04B 33/32

(52) U.S. Cl. 264/648; 501/141

(57) ABSTRACT

Disclosed herein is a composition comprising 50 to 73% by weight of loess, 9 to 20% by weight of clay, 3 to 10% by weight of wood flour, 3 to 7% by weight of lignum carbonized carbon body powder, 11 to 15% by weight of water and 1 to 5% by weight of ceramic glaze to manufacture a ceramic moulding including a carbon layer therein. Preferably, the composition according to the present invention further comprises elvan powder and Schmotte. Meanwhile, the present invention also provides a method of manufacturing a ceramic moulding with a carbon layer comprising forming a moulding out of the composition and firing the formed moulding with oxidizing flames.

### TECHNICAL FIELD

The present invention relates to a composition for a ceramic moulding of dual structure including a carbon layer therein, and a method of manufacturing a ceramic moulding using the same, wherein the composition comprises loess, clay, wood flour, lignum carbonized carbon body powder and a ceramic glaze.

### BACKGROUND ART

A conventional typical clay brick is manufactured by mixing clay and quartz sand, drying the mixture and then firing at temperatures of 1100 to 1200° C. Such clay brick has a shortcoming in that a completed clay brick is heavy since a mixture of clay and quartz sand is comparatively heavy.

Thus, in order to lessen the weight of a clay brick, a brick further comprising wood flour such as sawdust or chaff in the mixture of clay and quartz sand has been suggested. However, such brick has shortcomings in that wood flour remains partially as a carbon body due to firing flames in firing process, or is burned out completely thereby forming a porous brick and thus damaging its appearance.

In order to improve the problem of adding wood flour, a method of providing different heat sources per steps to progress firing has been suggested. In brief, wood flour is firstly burned by firing with reducing flames, thereby forming carbon bodies wholly, and the carbon bodies only at surface are vaporized completely by firing neutral flames or oxidizing flames providing oxygen for a specific time, thereby remaining inner carbon bodies intact. However, such method has shortcomings in that the operation becomes complex since different heat sources must be provided, and the indispensable use for expensive reducing flames (reducing flames at a specific temperature require more fuel cost and longer heating time relative to oxidizing flames) makes it uneconomical. Furthermore, more attention is required to be paid to provision of oxidizing flames since if it takes a long time for providing oxidizing flames, even inner carbon bodies may be vaporized.

### DISCLOSURE

### Technical Problem

A ceramic moulding is needed that can form a carbonized carbon layer even though fired with oxidizing flames, and accordingly can be manufactured economically and simply. Meanwhile, superior fire resistance, heat resistance, adiabatic property and odor-removing ability, etc. are required for the ceramic moulding to be manufactured.

### Technical Solution

In order to achieve the above object, the invention provides a composition for manufacturing a ceramic moulding with a carbon layer, the composition comprising 50 to 73% by weight of loess, 9 to 20% by weight of clay, 3 to 10% by weight of wood flour, 3 to 7% by weight of lignum carbonized carbon body powder, 11 to 15% by weight of water and 1 to 5% by weight of ceramic glaze. Preferably, the composition according to the present invention further comprises elvan powder and Schmotte in such a manner as to comprise 50 to 68% by weight of loess, 9 to 20% by weight of clay, 3 to 10% by weight of wood flour, 3 to 7% by weight of lignum carbonized carbon body powder, 11 to 13% by weight of water, 1 to 5% by weight of ceramic glaze, 2 to 5% by weight of elvan powder and 3 to 7% by weight of Schamotte.

The ceramic glaze is preferably formed by mixing 0.4 to 2% by weight of terra alba, 0.5 to 2% by weight of limestone and 0.1 to 1% by weight of ash based on the total weight of the composition.

Meanwhile, the present invention also provides a method of manufacturing .a ceramic moulding with a carbon layer comprising forming a moulding out of the composition and firing the formed moulding with oxidizing flames. Preferably, the firing step is carried out with oxidizing flames at 1150 to 1250° C.

Hereinafter, the present invention is described in detail.

1. A Composition for a Ceramic Moulding with a Carbon Layer

(1) A composition for a ceramic moulding with the carbon layer according to the present invention comprises 50 to 73% by weight of loess, 9 to 20% by weight of clay, 3 to 10% by weight of wood flour, 3 to 7% by weight of lignum carbonized carbon body powder, 11 to 15% by weight of water and 1 to 5% by weight of ceramic glaze.

The composition according to the present invention comprises particularly lignum carbonized carbon body powder and ceramic glaze with wood flour. Due to their action, a ceramic moulding of dual structure including a carbon layer therein can be manufactured even though firing with oxidizing flames only.

Loess and clay are main components for manufacturing the ceramic moulding. Loess contained in much amounts in the present invention serves as an eco-friendly factor when completed as a construction material such as a brick.

Further, wood flour is used in the form of sawdust, and the ceramic moulding comprising it provides durability and far infrared ray emission effect since when it is fired, it becomes a carbon body. In addition, wood flour plays a role in manufacturing a light-weighted ceramic moulding since when it is fired, it is carbonized and at surface of the moulding is even burned.

Lignum carbonized carbon body powder in addition to wood flour is directly contained in the composition according to the present invention in order to provide a satable carbon body and diminish the time for wood flour to be carbonized. Lignum carbonized carbon body powder refers to powdered carbon body such as charcoal, lignite and graphite prepared by carbonizing lignum of wood, etc. Lignite powder is most economical as the lignum carbonized carbon body powder.

Further, the composition according to the present invention comprises a ceramic glaze in the amount of 1 to 5% by weight relative to the total weight of the composition that is raw material for manufacturing a formed moulding, not applying the ceramic glaze to the surface of the formed moulding. The purpose of adding the ceramic glaze is to complete a ceramic moulding of dual structure including a carbon layer therein even though firing with oxidizing flames only. The ceramic glaze is preferably formed by mixing 0.4 to 2% by weight of terra alba, 0.5 to 2% by weight of limestone and 0.1 to 1% by weight of ash based on the total weight of the composition. The terra alba is used as a normal ceramic glaze material and is a kind of soil.

Water is contained in the amount of 11 to 15% by weight based on the total weight of the composition in order to bind mixtures.

(2) Meanwhile, the composition according to the present invention further comprises elvan powder and Schmotte, and thus the composition preferably comprises 50 to 68% by weight of loess, 9 to 20% by weight of clay, 3 to 10% by weight of wood flour, 3 to 7% by weight of lignum carbonized carbon body powder, 11 to 13% by weight of water, 1 to 5% by weight of ceramic glaze, 2 to 5% by weight of elvan powder and 3 to 7% by weight of Schamotte. The component range of the composition is optimized one to express the properties of each component.

Elvan powder has strong adsorbing property since it consists of micropores, and serves to exchange a heavy metal with an ion and also has the property of emitting far infrared ray since it contains inorganic salts. Such properties are also expressed as it is in the present invention.

Schamotte is prepared by heating a fire-resistant clay with high temperatures of 1300 to 1400° C. and then breaking to grains below 3 mm, and is added to diminish the contraction rate on firing with enhancing fire resistance.

The addition of Schamotte ensures that when a ceramic moulding with a carbon layer according to the present invention is made into a construction material such as a brick or a moulding such as a kiln requiring fire resistance, such fire resistance can be given.

When Schamotte is further added, water can be contained in the amount of 11 to 13% by weight, which is less than on forming a usual ceramic product on consideration of the effect that the contraction rate is diminished due to the addition of Schamotte.

2. Method of Manufacturing a Ceramic Moulding with a Carbon Layer

A method of manufacturing a ceramic moulding with a carbon layer according to the present invention comprises (1) forming a moulding out of the composition for a ceramic moulding with a carbon layer, and (2) firing the formed moulding with oxidizing flames.

The composition according to the present invention comprises the ceramic glaze as raw material for manufacturing a formed moulding. In the present invention, the ceramic glaze is not applied to the surface of the formed moulding. The purpose of adding the ceramic glaze is to complete a ceramic moulding of dual structure including a carbon layer therein even though firing with oxidizing flames only.

If a formed moulding is manufactured with a raw material not comprising a ceramic glaze and is instantly fired with oxidizing flames, wood flour and lignum carbonized carbon body powder are burned and vaporized (carbon components are exited out), thereby forming mircopores and thus porous ceramic moulding. Meanwhile, If a formed moulding is manufactured with a raw material not comprising a ceramic glaze and is applied with a ceramic glaze and then fired with oxidizing flames, a film is formed by the ceramic glaze and thus wood flour and lignum carbonized carbon body powder are burned, but are confined without being vaporized since they are interrupted by the ceramic glaze film, thereby completing ceramic moulding in which carbon bodies are wholly formed.

Meanwhile, In the present invention since a formed moulding is manufactured with a composition comprising a ceramic glaze, it is instantly fired with oxidizing flames without treating with reducing flames as in the previous method. Thus, before the ceramic glaze forms a film, wood flour and lignum carbonized carbon body powder at the surface of the formed moulding are burned and vaporized. Meanwhile, the ceramic glaze forms a film while the wood flour and the lignum carbonized carbon body powder present the inside of the formed moulding are burned. Accordingly, the wood flour and the lignum carbonized carbon body powder present the inside of the formed moulding are burned, but not vaporized any more and confined to the inside of the formed moulding. Thus, a ceramic moulding of dual structure, within which a carbon body is formed, is completed.

Here, the temperature at the firing step is preferably 1150 to 1250° C., which is a firing temperature for a general ceramic in a kiln. Firing operation must be controlled to properly carry out in a general manner in consideration of changes in fire flow, fire color, smoke, etc.

### Advantageous Effects

The ceramic moulding with a carbon layer according to the present invention manufactured as described above has superior adiabatic property, high heat resistance and an effect of emitting far infrared ray evenly since it includes a carbonized carbon layer therein.

### DESCRIPTION OF DRAWINGS

FIG. 1 is a photograph for a section of a ceramic moulding (brick form) with a carbon layer according to the present invention;

FIG. 2 is a photograph for a section of a ceramic moulding (plate form) with a carbon layer according to the present invention;

FIG. 3 is a photograph for a ceramic stove manufactured with a ceramic moulding with a carbon layer according to the present invention; and

FIG. 4 illustrates the amount of emitting far infrared ray in the ceramic moulding with a carbon layer according to the present invention.

### MODE FOR INVENTION

Hereinafter, the present invention will be described in detail with reference to examples.

### Example 1

A composition was mixed in a component ratio described in Table 1 below, and was formed into mouldings in brick form and plate form, and then the formed mouldings were fired with oxidizing flames in a kiln at 1200° C.

TABLE 1

| | | | | | | Carbon body | | |
|---|---|---|---|---|---|---|---|---|
| | | | | | Wood | powder | | |
| | | | Elvan | | flour | (lignite | | Ceramic |
| Material | Loess | Clay | powder | Schamotte | (saw dust) | powder) | Water | glaze |
| Wt % | 54 | 15 | 2 | 4 | 7 | 4 | 11 | 2(Terra alba 0.8 |
| | | | | | | | | Limestone 0.8 |
| | | | | | | | | Ash 0.4) |

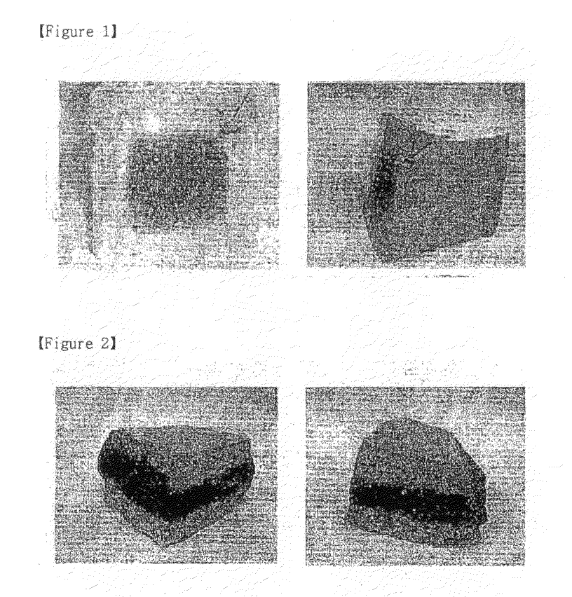

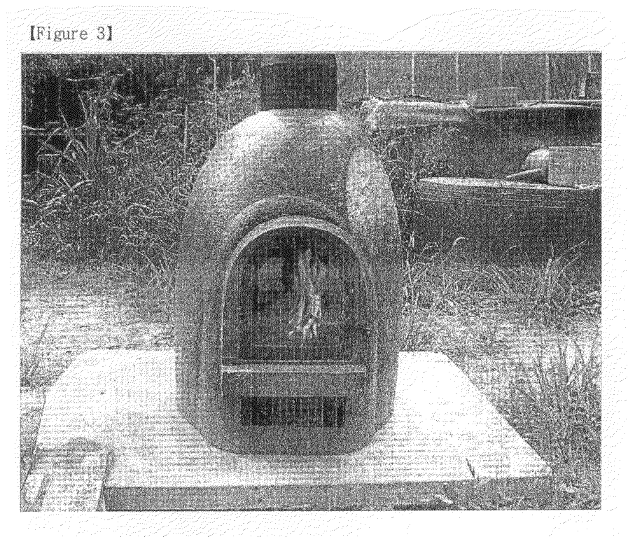

The photographs for sections of ceramic mouldings after firing were taken and the results are shown in FIGS. 1 and 2. From observation for the sections, it can be ascertained that the ceramic moulding according to the present invention was formed as dual structure having black carbon layer therein.

### Example 2

A composition was mixed in a component ratio described in Table 1 in Example 1, and was formed into stove form, and then the formed stove form were fired with oxidizing flames at 1200° C. to manufacture a ceramic stove.

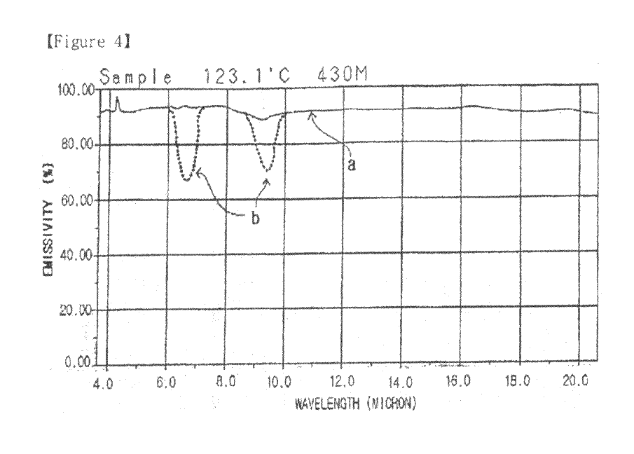

Usual ceramics tend to be cracked and broken easily at quick heating or quenching circumstance. However, the ceramic stove manufactured according to the present invention as shown in FIG. 3 has high fire resistance and heat resistance, and accordingly is not cracked even at quick heating or quenching circumstance which occurs when making a fire and cooling. Further, it can be found that the ceramic moulding manufactured according to the present invention has superior adiabatic property since one does not get burned in the hand even on touching the outside of the stove when the inner temperature of the stove exceeds 900° C.

When a ceramic stove is manufactured with a ceramic moulding with a carbon layer according to the present invention, the effect of emitting far infrared ray highly can be obtained due to the property of a carbon layer in which the value of emitting far infrared ray is maximized on heating. The carbon layer within the ceramic stove is not vaporized and thus kept intact even though the stove is kept using with stoking since the ceramic glaze forms a film.

Meanwhile, the ceramic moulding according to the present invention can be given in large size as shown in FIG. 3 unlike previous ceramics were manufactured only in small size.

Test 1 Example 1. Quantitative Analysis

The components of the ceramic moulding manufactured according to Example 1 were analyzed quantitatively, and the results are presented in Table 2 below. Experiment was ordered to Ceramics Institute in Gifu, Japan, and carried out according to JIS R 2216 method.

TABLE 2

| Analysis item | Analysis value (wt %) |
|---|---|
| SiO | 54.2 |
| AlO | 28.6 |
| FeO | 3.29 |
| TiO | 0.56 |
| CaO | 2.50 |
| MgO | 0.88 |
| KO | 1.92 |
| NaO | 0.86 |
| Ig.Loss | 6.90 |

From quantitative analysis for the ceramic moulding according to the present invention described above, the components of calcium oxide and magnesium oxide were found unlike the components found in the ceramic moulding manufactured with loess. The components are usually found in charcoal. The reason why the above components were found appears because the ceramic moulding according to the present invention forms a carbon layer through firing process by wood flour and lignum carbonized carbon body powder.

Test 1 Example 2. Emission of Far Infrared Ray

The emission rate of far infrared ray for the ceramic moulding manufactured according to Example 1 was measured by JIS R 1801 method in Ceramics Institute in Gifu, Japan.

The graph showing the results is shown in FIG. 4. The part indicated with continuous line of ‘a’ in FIG. 4 shows the emission rate of far infrared ray about the ceramic moulding manufactured according to the present invention. The part indicated with partially dotted line of ‘b’ in FIG. 4 is shown for comparison. For natural mineral, there is a part in which far infrared ray appeared low like ‘b’ at 6 to 12 micron region called cultivation ray. On the contrary, it was measured that the ceramic moulding according to the present invention showed constantly high emission rate. Further, the emission rate of the ceramic moulding according to the present invention was measured as an average 93.5%. Since the high emission rate is an average 90% only even for a mineral called Cheonchang stone, it can be found that the ceramic moulding according to the present invention shows more superior emission rate of far infrared ray.

Test 1 Example 3: Anion Accumulating Ability

After forming into house form with a composition mixed with the component ratio described in Table 1 of Example 1, a ceramic house was manufactured by firing with oxidizing flames at 1200° C. as in Example 1. Then an anion counter equipment (Ion Counter & Recorder, double cylindrical one electrode mode measurement) was set in its inside and outside, and the change in the value of the anion generated in atmosphere was measured at 10:00 to 17:00. The measuring authority was Korea Testing Laboratory. The results for measuring anion are presented in Table 3 below.

TABLE 3

| | | Ceramic house | | | | Comparison |
|---|---|---|---|---|---|---|
| | | Inside | | | | Inside of a |
| | | 1^{st} | 2^{nd} | | Outside | general |
| | | measure | measure | Average | (near 10 m) | house |
| Measuring date | | 8.30~9.2 | 9.30~10.3 | | 9.30~10.3 | 10.4 |
| Measuring | Average | 20 | 18 | 19 | 20 | 18 |
| condition | temperature | | | | | |
| | (° C.) | | | | | |
| | Average | 65 | 60 | 62.5 | 40 | 40 |
| | humidity (%) | | | | | |
| Measured | MAX | −1.989 | −1.511 | −1.750 | −0.854 | −0.255 |
| valued | MIN | −0.581 | −1.239 | −0.910 | −0.082 | −0.130 |
| (10³/cc) | Average | −1.124 | −1.407 | −1.266 | −0.542 | −0.188 |

When comparing the inside of the ceramic house with the inside of a general house, the value of the generated anion was shown as maximum 7.8 fold (−1.989/−0.255), minimum 4.5 fold (−0.581/−0.130), and average 6.7 fold (−1.266/−0.188). When comparing the inside and outside of the ceramic house, it was shown that the value of the inside was average 2.34 fold high. In conclusion, the ceramic moulding according to the present invention has high rate for anion generation.

### INDUSTRIAL APPLICABILITY

According to the present invention, it is possible to complete a ceramic moulding of dual structure with a carbon layer even though fired with oxidizing flames only through forming a moulding out of a composition comprising wood flour, lignum carbonized carbon body powders and a ceramic glaze together, and accordingly can be manufactured economically and simply.

The ceramic moulding according to the present invention can be light-weighted by vaporizing wood flour and lignum carbonized carbon body powder partially during firing process. The ceramic moulding can be employed as eco-friendly construction material such as a brick and a tile, etc. since it gives constantly high emission rate of far infrared ray and has anion accumulating ability, moisture conditioning ability, odor-removing ability and superior adiabatic property. Meanwhile, the ceramic moulding can be formed in large size, and thus can be manufactured into a general house or a Jjimjilbang, etc. Further, it can be also anticipated as use of a ceramic stove and a heat collecting panel for a solar cell, etc. since it does not deform even on quenching or quick heating, and has high heat resistance and fire resistance.

1. A composition for manufacturing a ceramic moulding with a carbon layer, the composition comprising 50 to 73% by weight of loess, 9 to 20% by weight of clay, 3 to 10% by weight of wood flour, 3 to 7% by weight of lignum carbonized carbon body powder, 11 to 15% by weight of water and 1 to 5% by weight of ceramic glaze.

2. The composition according to claim 1, wherein the composition further comprises elvan powder and Schmotte in such a manner as to comprise 50 to 68% by weight of loess, 9 to 20% by weight of clay, 3 to 10% by weight of wood flour, 3 to 7% by weight of lignum carbonized carbon body powder, 11 to 13% by weight of water, 1 to 5% by weight of ceramic glaze, 2 to 5% by weight of elvan powder and 3 to 7% by weight of Schamotte.

3. The composition according to claim 2, wherein the ceramic glaze is formed by mixing 0.4 to 2% by weight of terra alba, 0.5 to 2% by weight of limestone and 0.1 to 1% by weight of ash based on the total weight of the composition.

4. A method of manufacturing a ceramic moulding with a carbon layer, the method comprising forming a moulding out of the composition according to any one of claims 1 to 3, and firing the formed moulding with oxidizing flames.

5. The method according to claim 4, wherein the firing step is carried out with oxidizing flames having a firing temperature of 1150 to 1250° C.
